(19) United States
(12) Patent Application Publication
(10) Pub. No.: US 2008/0168755 A1
(43) Pub. Date: Jul. 17, 2008

(54) Harvesting Implement, Particularly Front Harvesting Attachment For Agricultural Harvesting Machines For Taking Up Cereal Crops and Conveying It Further

(76) Inventors: Clemens Rickert, Stadtlohn (DE); Martin Huning, Billerbeck (DE); Leo Schulze Hockenbeck, Everswinkel (DE); Klemens Weitenberg, Borken (DE)

Correspondence Address: W. Michael Dixon;Patent Department, Deere & Company, 1 John Deere Place, Moline, IL, 61265, US

(21) Appl. No.: 11/883,278

(22) PCT Filed: Jan. 20, 2006
(86) PCT No.: PCT/EP06/50344

§ 371 Date: Jul. 27, 2007

(30) Foreign Application Priority Data
Jan. 29, 2005 (DE) 10 2005 004 211.2

(51) Int. Cl. A01D 41/14

(52) U.S. Cl. 56/10.2 E

(57) ABSTRACT

The invention concerns a harvesting implement, particularly a front harvesting attachment (14) for agricultural harvesting machines (10) for taking up and conveying cereal crops further, for example, corn plants, and that can be moved across a field during the harvesting operation in a forward operating direction, with a center part (36), a first side part (32) and a second side part (34) that are connected in joints on each side of the center part (36) so as to pivot between an operating position and a transport position about a first or a horizonta horizonta second horizontal axis (38, 40) extending in the forward operating direction, where the center part (36) and the side parts (32, 34) include mowing and conveying elements (16, 18, 20) arranged alongside each other in the operating position and the mowing and conveying elements (16, 20) of the side parts (32, 34) are located above mowing and conveying elements (18) of the center part (36) in the transport position.

The invention proposes that the first axis (38) be arranged at a first height in such a way that the first side part (32) is arranged in the transport position approximately horizontally above the center part (36), and that the second axis (40) be arranged at such a height that the second side part (38) be located approximately horizontally above the first side part (32) in the transport position.

The invention concerns a harvesting implement, particularly a front harvesting attachment for agricultural harvesting machines for taking up cereal crop and conveying it further, for example, corn plants, which can be moved in a forward operating direction across a field during the harvesting operation, the implement includes a center part, a first side part and a second side part that are connected in joints, free to pivot, each of which is connected in joints to either side of the center part and can be pivoted about a first or a second horizontal axis extending in the forward operating direction between an operating position and a transport position, there the center part and the side parts include mowing and conveying elements arranged side-by-side in the operating position and the mowing and conveying elements of the side parts are located above the mowing and conveying elements of the center part in the transport position.

At the present time the agricultural machinery industry offers ever wider front harvesting attachments for self-propelled harvesting machines that would permit the agriculturalist to harvest a field in shorter time and with fewer crossings of the field, however the maximum width of vehicles operating on public roads is limited by law. As a result the front harvesting attachments, as a rule, are transported on a trailer or are folded into a transport position in which their width is reduced compared to their operating position. The folding has the advantage that the removal and subsequent reattachment of the front harvesting attachment from or to the harvesting implement for the sake of transporting it on a trailer can be omitted.

DE 41 31 491 A describes a corn harvesting implement for forage harvesters, in which the outer parts can be folded upward about horizontal axes extending in the forward operating direction. According to EP 0 491 405 A the side parts are pivoted about horizontal axes extending in the forward operating direction and deposited horizontally upon the center part, whereas DE 298 17 666 U proposes, in the case of a five-part front harvesting attachment, that the inner side parts be pivoted vertically upward in the transport position and, on the other hand, to rotate the outer side parts inward, so that the outer side parts are arranged above the center part.

Finally DE 195 23 255 A proposes that the side parts be fastened to support arms connected in joints to the center of the center part. After raising the support arms the side parts are pivoted through approximately 90° to the front about pivot axes arranged at the ends of the support arms. Since each of the pivot axes of the side parts are oriented differently in the support arms, the forward regions of the side parts that are forward during the operation are located above one another in the transport position.

While in the embodiments according to DE 195 23 255 A and DE 298 17 666 U relatively costly pivoting mechanisms are used, that require two pivot axes and associated drives for each side part, the embodiment according to EP 0 491 405 A has the disadvantage that the width of the side parts is limited to one-half of the width of the center part. Therefore at present such a front harvesting attachment is limited to a width of approximately 6 to 7 meters. The highly projecting side parts of the embodiment according to DE 41 31 491 A lead to a center of gravity located at a high level for the front harvesting attachment in the transport position that results in an inappropriate operating condition for the harvesting machine.

The purpose underlying the invention is seen in the need to define a front harvesting attachment that is improved in comparison to the above.

This purpose is met according to the invention by the teaching of patent claim 1, where the further patent claim cites characteristics that further develop the solution to great advantage.

A harvesting implement according to the invention includes a center part and side parts connected in joints to the center part, free to pivot about horizontal axes extending in the forward operating direction. The invention proposes that the first axis, about which the first side part can pivot, be arranged at a height above the center part that permits the first side part to rest flat upon the center part in the transport position. The second side part is connected in joints to the center part, free to pivot about a second axis that is arranged at a greater height than the first axis. In the transport position this makes it possible to deposit the second side part flat upon the first side part which has been pivoted inward.

In this way the result, with relatively simple means, is an operating width that corresponds to triple the transport width of the front harvesting attachment.

The invention is appropriate for all types of front harvesting attachments, such as, corn heads, corn pickers or mowing arrangements, that can be applied to harvesting machines, particularly self-propelled, or attached, or towed forage harvesters or combines. The conveying of the harvested crop into the harvesting machine is not an absolute requirement, so that the invention could also be applied, for example, to carrier vehicles with mowing implements in the form of rotary mowers or mowing disks or the like for mowing grass with pivoted side parts. Accordingly the side parts need not be connected in joints directly to the center part, but may be supported at any desirable other location, free to pivot from the support vehicle.

The drawing shows an embodiment of the invention that shall be described in greater detail in the following.

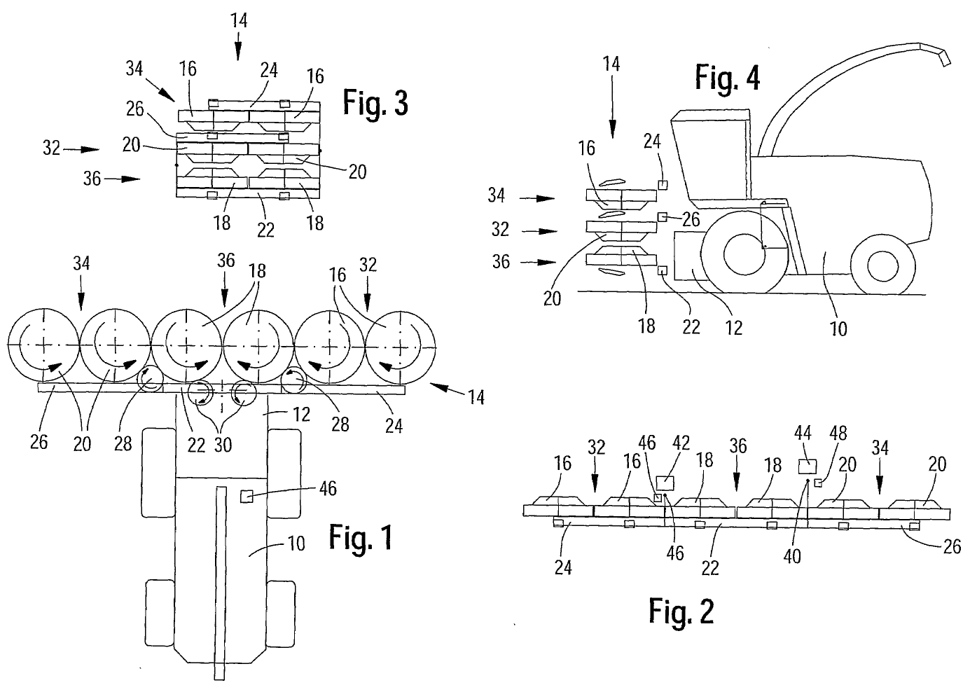

FIG. 1 shows a plan view of a self-propelled harvesting machine with a front harvesting attachment arranged thereto.

FIG. 2 shows a front view of the front harvesting attachment in the operating position.

FIG. 3 shows a front view of the front harvesting attachment in the transport position.

FIG. 4 shows a side view of the harvesting machine and the front harvesting attachment in the transport position.

FIG. 1 shows a plan view of a self-propelled harvesting machine 10 in the form of a forage harvester, known in itself, with an intake channel 12 of the harvesting machine 10 and with a removable front harvesting attachment 14. The front harvesting attachment 14 that is shown as an embodiment of a harvesting implement is configured in the form of a mowing machine and includes six mowing and conveying elements 16, 18, 20 arranged alongside each other for the cutting and taking up stalk-like harvested crop, such as corn. Since this is only an embodiment, any other desired number and embodiments of mowing and conveying elements 16, 18, 20 could also be applied, particularly with endless conveyors.

The front harvesting attachment 14 includes a support frame composed of a center section 22 and two outer sections 24, 26 arranged on both sides of the center section. Each of the outer sections 24, 26 of the support frame carry two mowing and conveying elements 16 or 20, while the center section 22 of the support frame carries the center mowing and conveying elements 18.

The harvested material separated from the ground by the mowing and conveying elements 16, 18, 20 in the harvesting region driven by a drive line from the harvesting machine 10, rotating about the vertical axis, is conveyed into the intake channel 12 of the harvesting machine 10 along the rear sides of the mowing and conveying elements by transverse conveying drums 28 attached to the outer sections 24, 26 of the support frame and slope conveyor drums 30 attached to the center section 22, from which it is chopped and ejected onto a transport vehicle.

The right outer section 24 of the support frame as seen in the forward operating direction of the harvesting machine 10 forms a first side part 32 of the front harvesting attachment 14 together with mowing and conveying element 16 along with the associated conveying drums 26 attached thereto. The left outer section 26 of the support frame, as seen in the forward operating direction of the harvesting machine 10 form a second side part 34 of the front harvesting attachment 14 together with mowing and conveying elements 20 along with the associated conveying drums 28 attached thereto. The center section 22 of the support frame forms a center part 36 of the front harvesting attachment 14 together with the mowing and conveying elements 18 and the associated slope conveyor drum 30. Accordingly, in the operating position shown in FIGS. 1 and 2, the side parts 32, 34 are located in a single plane as seen in the forward operating direction alongside the center part 36.

In order to reduce the width of the front harvesting attachment 14 for transport on public roads and thereby to save the effort of removal and subsequent reattachment of the front harvesting attachment 14 to the harvesting machine 10, the front harvesting attachment 14 can be brought into a transport position shown in FIGS. 3 and 4. The position of the center part 36 does not change relative to the intake channel 12 in the transport position as against the operating position. The first side part 32 is connected in joints to the center section 22 of the center part 36, free to pivot about a first horizontal axis 38 extending in the forward operating direction, while the second side part 34 is connected in joints to the center section 22 of the center part 36 so as to pivot about a second horizontal axis 40 extending in the forward operating direction. The first axis 38 is arranged above the section 24 of the support frame, and the second axis 40 is located at a higher level than the first axis 38 above the section 26. Associated drives 42, 44 are arranged so as to pivot the side parts 32 or 34 into the transport position about the axes 38 or 40. The drives 42, 44 may be rotational drives, for example, hydraulic motors or they may be linear drives, for example, hydraulic cylinders that are connected to the side parts 32, 34 over appropriate drive lines, such as rope pulls or linkages known in themselves (see DE 33 24 458 A and U.S. Pat. No. 4,355,690 A, whose disclosures are incorporated by reference into the present documents).

The first axis 38 is arranged in such a way that the first side part 32 is pivoted through 180° inward in the transport position and lies flat and horizontally above the center part 36. The second axis 40 is arranged analogously in such a way that the second side part 34 is pivoted inward through 180° in the transport position and lies flat and horizontally above the first side part 32. In this way the result is a reduction of the transport width to one-third of the operating width. To reduce the load on the drives 42, 44 the first side part 32 can be supported in the transport position on the center part 36 and the second side part 34 on the first side part 32 and/or the center part 36. Furthermore a locking of the side parts 32, 34 in the transport position and/or in the operating position is useful.

Preferably the drives 42, 44 are connected to a control arrangement 46 that may be located on board the harvesting machine 10 or on the front harvesting attachment 14. During the transfer from the operating position to the transport position the control arrangement 46 can be operated to first pivot the first side part 32 until it has reached the transport position or at least until it has been pivoted to such a degree that no collision with the second side part 34 is possible. This position can be detected by a sensor 46¹ that recognizes the position of the first side part 32, for example, by a switch actuated when the first side part 32 reaches the aforementioned position or by a potentiometer actuated by the movement of the first side part 32. Alternatively or in addition the operating time of the drive 42 of the first side part 32 is determined and a release signal issued for the drive 44 of the second side part 34 as soon as a time interval has elapsed that is sufficient for the first side part 32 to reach the aforementioned position. Then the drive 44 of the second side part 34 is activated. The reverse movement is performed in the reverse order where the drive 42 of the first side part 32 is analogously activated only when a sensor 48 indicates that the second side part 34 has reached a position in which a collision with the first side part 32 is no longer possible. ¹Translators Note sensor 46 should be sensor 48.

1. Harvesting implement, particularly front harvesting attachment (14) for agricultural harvesting machines (10) for taking up and conveying cereal crops further, for example, corn plants and that can be moved over a field in the forward operating direction during the harvesting operation, with a center part (36), a first side part (32) and a second side part (34) that are connected in joints so as to pivot between an operating position and a transport position and are attached to each side of the center part (36) and that can pivot about a first or a second horizontal axis (38, 40) extending in the forward operating direction, where the center part (36) and each of the side parts (32, 34) include mowing and conveying elements (16, 18, 20) arranged alongside each other in the operating position and where mowing and conveying elements (16, 20) of the side parts (32, 34) are located above mowing and conveying elements (18) of the center part (36) in the transport position, characterized by the first axis 38 that is arranged at such a height that the first side part 32 is located horizontally above the center part 36 in the transport position and that the second axis 40 is arranged at a second height so that the second part 36 is located horizontally above the first side part 32.

2. Harvesting implement according to claim 1, characterized by the side parts (32, 34) that have approximately the width of the center part (36).
